(19) United States
(12) Patent Application Publication
(10) Pub. No.: US 2024/0296013 A1
(43) Pub. Date: Sep. 5, 2024

(54) PSEUDO RANDOM NUMBER GENERATION

(71) Applicant: William D. Schwaderer, Sparks, NV (US)

(72) Inventor: William D. Schwaderer, Sparks, NV (US)

(21) Appl. No.: 18/595,121

(22) Filed: Mar. 4, 2024

Related U.S. Application Data
(60) Provisional application No. 63/488,402, filed on Mar. 3, 2023.

(51) Int. Cl. G06F 7/58

(52) U.S. Cl. CPC G06F 7/582

(57) ABSTRACT

The disclosure is directed to a multiplicity-dimensioned array of pseudo random number generation means, each array member using an independent selector pseudo random number generator means to generate a pseudo random number value used to identify a second pseudo random number generator means within a multiplicity of pseudo random number generator means, the second pseudo random number generator means producing a value that is returned to a pseudo random number generator requestor unchanged.

### CROSS-REFERENCE TO RELATED APPLICATION

The present application claims priority to U.S. Provisional Application No. 63/488,402, entitled “IMPROVED PSEUDO RANDOM NUMBER GENERATION”, and filed on Mar. 3, 2023. The entire contents of the above-listed application are hereby incorporated by reference for all purposes.

### BACKGROUND AND SUMMARY

Numerous important computer applications, such as Monte Carlo simulations and data cryptography, utilize output sequences generated by Pseudo Random Number Generators (PRNGs). For such applications, it is beneficial for the PRNG-generated sequence to be computationally indistinguishable from True Random Number sequences. This prevents PRNG-generated sequences from exhibiting bias that can undesirably skew simulation results or, in the case of cryptography applications, adversely exhibit identifiable and exploitable patterns within generated ciphertext.

Specifically, with cryptography applications, using PRNG output sequences that are not computationally indistinguishable from True Random Number sequences can introduce significant ciphertext vulnerabilities that subsequent pattern and periodicity analysis can detect and exploit, thereby completely compromising (cracking) cryptographic security.

Specifically, in a 1968 paper titled “Random numbers fall mainly in the planes”, G. Marsaglia noted a serious LCG weakness by showing that, for any given k, all k-tuples (Uᵢ₊₁, . . . , Uᵢ₊ₖ) of successive values a LCG generates lie on a set of, at most, (k! m)^{1/k} equidistant parallel hyperplanes in the k-dimensional (0, 1)^{k} hypercube. If the number of hyperplanes is too small, this seriously constrains k-dimensional uniformity.

Unfortunately, many, if not most, PRNGs produce Pseudo Random Number (PRN) output sequences that immediately, or eventually, exhibit bias or otherwise identifiable output patterns. Therefore, there is significant value in PRNG methods that produce PRNG sequences that avoid introducing these significant vulnerabilities.

There are many types of PRNGs. A Nov. 19, 2022 Internet Web search reveals a Wikipedia Pseudorandom number generators (PRNGs) page that lists over 30 types of PRNGs. Moreover, individual PRNG types can each have many variants.

For example, practitioners having ordinary skill in the art appreciate that there are many different sizes of Linear Feedback Shift Registers (LFSRs) that can be used as PRNGs. Specifically, a LFSR may be 4-bit, 8-bit, 10-bit, 11-bit, 16-bit, 17-bit, 24-bit, 29-bit, etc. in size. Moreover, each LFSR of a given size could use one of a multiplicity of different feedback polynomials, including some that are not one of the multiplicity of primitive polynomials that enable the LSFR to produce maximum-length sequences before repeating a previously produced sequence.

Finally, different PRNGs and their different variations have different performance (processing) impacts and introduce different output sequence artifacts that cryptographic analysis can detect and exploit. These differences can be important to applications. It is often advantageous, or imperative, to prevent these weaknesses for the afore mentioned reasons.

Embodiments of the present disclosure teach that there is significant value in constructing a means to generate PRN sequences using a multiplicity of different PRNG types, with each present type potentially having a multiplicity of variations in a constructed PRNG means. Individual members of the multiplicity of PRNGs can be accessed under pseudo random control in order to select which PRNG produces a requested PRN. This unpredictable selection approach significantly disrupts bias and obfuscates output patterns that individual PRNG PRN sequences can exhibit by introducing output sequence discontinuities.

### BRIEF DESCRIPTION OF THE DRAWINGS

FIG. 1 depicts an example of a PRNG Array that contains a Selector PRNG of some PRNG type and variation. The PRNG Array also contains a multiplicity of independent, possibly heterogeneous, PRNGs.

FIG. 2 depicts an example of a novel Fortified Linear Congruential Generator (LCG) with a flexible design.

FIG. 3 provides an example of a high-level summary of steps that can be taken to provide PRNs to requestors.

FIG. 4 depicts an example of a Chiplet implementation with multiple PRNG Array instantiations.

FIG. 5 depicts an example of a Modulus N PRNG Index Counter that provides the selection function Selector PRNG provides in FIG. 1.

### DETAILED DESCRIPTION

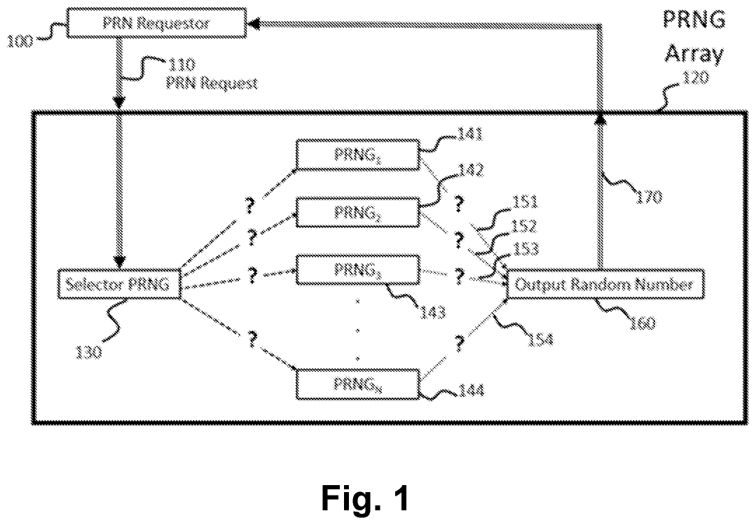

Examining FIG. 1, a PRNG Array 120 contains a Selector PRNG 130 of some PRNG type and variation. PRNG Array 120 also contains a multiplicity of independent, possibly heterogeneous, PRNGs 141, 142, 143, . . . , and 144. Each of the N independent PRNGs 141, 142, 143, . . . , and 144 is of some PRNG type and variation of the specific PRNG type. The value of N can be fixed for an application or can vary depending on a pseudo random number valuation method.

In FIG. 1, each of the N independent PRNGs 141, 142, 143, . . . , and 144 also has a unique index identifier. This unique index identifier allows Selector PRNG 130 independent access to each of the N independent PRNGs 141, 142, 143, . . . , and 144 using an index value Selector PRNG 130 computes and scales.

In FIG. 1, a computing application PRN Requestor 100 needs PRNG Array 120 to generate and return a PRN which it returns to its application. It is to be understood, the application using PRN Requestor 100 to obtain the PRN will typically have allocated PRNG Array 120 for its exclusive use and initialized its multiplicity of PRNs 130, 141, 142, 143, . . . and 144 using methods that vary with the specific design of PRNs 130, 141, 142, 143, . . . and 144. It follows that a computing system may require a multiplicity of PRN Array 120 components that are available for allocation. This supports multi-core, multi-processor, multithread applications requiring PRN values.

For PRN Requestor 100 to obtain a PRN from PRNG Array 120, PRN Requestor 100 emits a PRN Request 110 to the PRNG Array 120. A Selector PRNG 130 of some PRNG type and variation within the PRNG Array 120 receives the request after the request passes through the PRNG Array 120 boundary, enabling Selector PRNG 130 to receive the request.

Practitioners having ordinary skill in the art will appreciate that there are many different types of PRNG Array 120 interfaces. As embodiment examples, the PRNG Array 120 interface can be an invokable software Application Programming Interface (API) if PRNG Array 120 is implemented in software, a PRNG Array 120 hardware register interface (not pictured) if PRNG Array 120 is implemented in hardware, or a simple, direct-connect boundary passthrough interface (pictured).

After receiving a request, Selector PRNG 130 computes a PRN value using its PRNG method. Selector PRNG 130 next scales the computed PRN value to scale the value's range from 1 to N (inclusive). The scaled value is an index to select which PRNG 141, 142, 143, . . . , and 144 should produce the PRNG value PRN Requestor 100 requires.

It is to be understood that Selector PRNG 130 can be one of the PRNG 141, 142, 143, . . . , or 144 and that FIG. 1 depicts it as a standalone PRNG Array 120 component for discussion simplicity.

When generated, the selected PRNG 141, 142, 143, . . . , and 144 places the PRN into Output Random Number 160. Alternately, selected PRNG 141, 142, 143, . . . , and 144 can directly return the PRN to PRN Requestor 100. When the PRNG value is available in Output Random Number 160, PRNG Array 120 returns it 170 to PRN Requestor 100. PRNG Array 120 is now ready to accept another PRN Request 110 from PRN Requestor 100.

It is to be understood Output Random Number 160 can be a computer processing CPU register for PRNG Array 120 software implementations. Here, the PRN can be returned as a function return code.

It is also to be understood that PRNG Array 120 logic (not pictured) can perturb (modify) the PRN value selected PRNG 141, 142, 143, . . . , and 144 generated to avoid exposing the internal PRNG 141, 142, 143, . . . , and 144 state value of the selected PRNG 141, 142, 143, . . . , and 144 that generated the PRN.

It is also to be understood that those PRNG 141, 142, 143, . . . , and 144 PRNGs Selector PRNG 130 does not have generate the returned PRN 170 remain idle and do not compute an unneeded PRN. For PRNG Array 120 software implementations, this saves computing PRN values that are only discarded.

It is also to be understood that FIG. 1 depicts a configuration that contains a single PRNG Array 120. In practice, to support multiprogramming and multi-thread applications, a configuration may contain a multiplicity of PRNG Array 120 elements, each potentially accessed as an individual element within an array of PRNG Array 120 elements. In such configurations, and in configurations with a single PRNG Array 120, it may prove beneficial to provide a supporting configuration software driver with a suitable Application Program Interface (API) for PRN Requestor(s) 100 to access the instantiated configuration. The API would conceivably support a multiplicity of commands including, but not limited to, array configuration status queries (type(s), counts, count available for allocation, etc.); PRNG Array 120 allocation, initialization, and deallocation requests; and PRN value requests.

The driver could also provide measures to validate that requests presented to PRNG Array 120 elements have originated with a PRN Requestor 100 that has previously allocated the PRNG Array 120 element that should receive a presented request. These measures can help prevent malicious or inadvertent interference with an operating PRNG Array 120 element. Should such interference be detected, the driver can autonomously generate and return a superfluous PRN value to return to the requesting PRN Requestor 100. This superfluous PRN value conceals that PRN Requestor 100 has presented a detected, invalid request to a PRNG Array 120 element that PRN Requestor 100 has not allocated and represents a passive, silent error redirection.

The PRN Selector PRNG 130 computes and uses as a scaled index value to select which PRNG 141, 142, 143, . . . , and 144 computes the PRN that PRNG Array 120 returns to PRN Requestor 100 introduces PRN sequences with output discontinuities that obfuscate operational bias and output patterns that PRNG 141, 142, 143, . . . , and 144 may naturally produce in their individual output sequences.

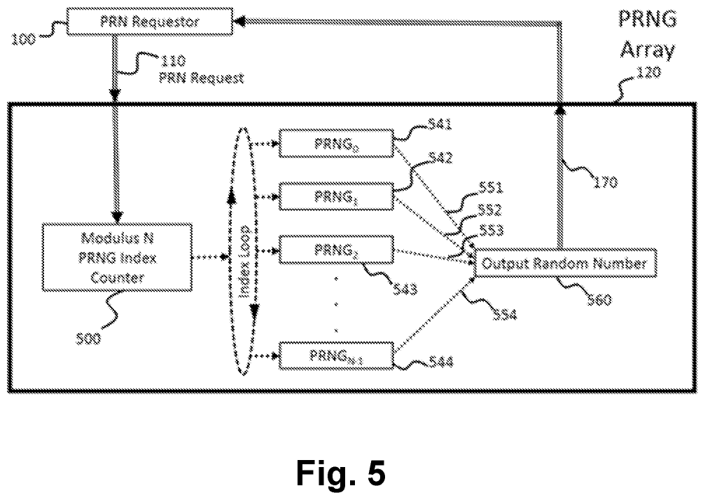

It is to be understood that FIG. 1 only depicts one of many possible embodiments in accordance with the present disclosure. As an embodiment example, in FIG. 5, the Modulus N PRNG Index Counter 500 provides the selection function Selector PRNG 130 provides in FIG. 1.

In FIG. 5, Modulus N PRNG Index Counter 500 can initially have a value of zero to N−1. After each access, Modulus N PRNG Index Counter 500 increments its value, performs a modulus N operation on the new value, and stores the modulus value in order to provide it to the next access. When the initial value is 0, Modulus N PRNG Index Counter 500 provides a looping index value sequence of 0, 1, 2, . . . , N−1, 0, 1, 2, . . . , N−1, 0, etc., sequentially accessing PRNGs 541, 542, 543, 544 in a continuously looping manner.

These various embodiment examples are provided as simple, clarifying explanations and are not meant to limit the scope of this invention.

Finally, it is to be understood, PRNG 141, 142, 143, . . . , and 144 may all be the same type and variant PRNG. In such instances, PRNG 141, 142, 143, . . . , and 144 produce different out sequences when they are initialized differently.

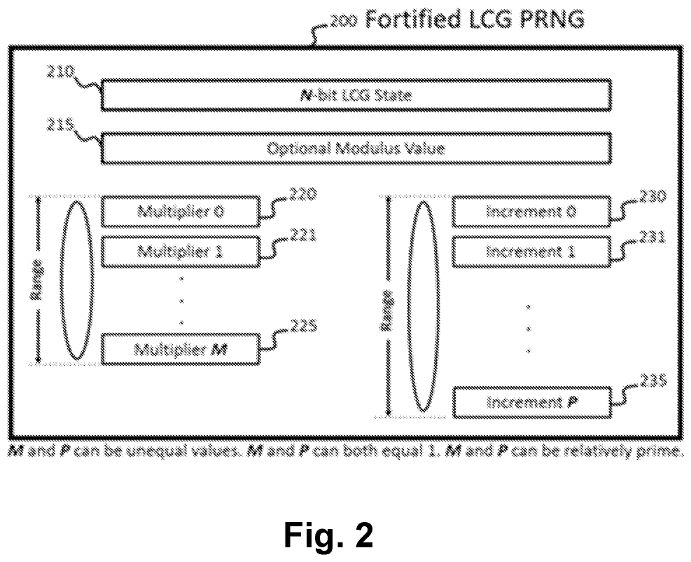

As an embodiment example, FIG. 2 depicts a novel Fortified Linear Congruential Generator 200 (LCG) with a flexible design. In FIG. 1, PRNG 141, 142, 143, . . . , and 144 could all use this design and be initialized differently.

In FIG. 2, practitioners having ordinary skill in the art will appreciate that the novel Fortified Linear Congruential Generator 200 has the traditional LCG N-bit LGC State 210. It also has provision for an LCG Optional Modulus Value 215 if a modulus value other than a default 2^{N} is desired. However, unlike traditional LCGs that only have one multiplier and one increment value, Fortified Linear Congruential Generator 200 has a M multiplicity of Multipliers 220, 221, . . . , 225 and a P multiplicity of Increments 230, 231, . . . , 235. The value of N and M can both be one, do not have to be the same value, and can be relatively prime.

For any PRN generation computation, Fortified Linear Congruential Generator 200 can use any of the Multiplier 220, 221, . . . , 225 and Increment 230, 231, . . . , 235 to perform a PRN computation. It is only necessary to select which Multiplier 220, 221, . . . , 225 and Increment 230, 231, . . . , 235 to use.

Multiplier 220, 221, . . . , 225 and Increment 230, 231, . . . , 235 selection can be achieved by sequentially using Multiplier 220, 221, . . . , 225 and Increment 230, 231, . . . , 235 in a looping manner. When Multiplier 225 or Increment 235 are used, Fortified Linear Congruential Generator 200 logic (not pictured) can return to using Multiplier 220 and Increment 230, respectively and continue looping. Alternately, Fortified Linear Congruential Generator 200 can incorporate independent selector PRNG and scaling logic (not pictured) that operates similarly to Selector PRNG 130 in FIG. 1.

It is to be understood that the values of Increment 230, 231, . . . , 235 can change after each individual access. As an embodiment example, the values of Increment 230, 231, . . . , 235 can change by performing a circular bit shift after each individual access. As a single embodiment example of this approach, Increment 230 may circular shift one bit position, Increment 231 may circular shift two bit position, and so forth, Finally. the number of circular bit position bit shifts can be fixed for an Increment or can be individually pseudo randomly determined.

As an embodiment example of a pure software embodiment, PRNG Array 120 can be a single software module that receives a single input argument. A computing system application performs a software call to the PRNG Array 120 module to exercise PRNG Array 120 passing the single input argument in the call.

As an embodiment example, if a call's argument is not a NULL pointer value, the pointer argument can point to an array of previously generated PRN values. PRNG Array 120 logic (not pictured) uses these values to construct and initialize Selector PRNG 130 and PRNGs 141, 142, 143, . . . , and 144 before returning to the calling program. Space for these several PRNGs can be obtained by using well know memory request procedures.

It is to be understood PRNG Array 120 logic (not pictured) can construct a temporary PRNG to generate PRNs that can initialize constructed PRNGs 141, 142, 143, . . . , and 144. Alternately, constructed and initialized Selector PRNG 130 can perform this initialization when it is constructed and initialized.

Continuing the example embodiment, if the call's argument is a NULL pointer value, the PRN Requestor 100 call is requesting PRNG Array 120 generate and return a PRN. Afore described logic generates the PRN and it is passed back to the calling application as a return code value. As also previously mentioned, PRNG Array 120 logic can modify the generated PRN value and return the modified value to avoid exposing the state of the PRNG 141, 142, 143, . . . , and 144 selected to generate the PRN.

Finally, for cryptography applications, the PRNG Array 120 construction must be identically repeated by subsequent decryption methods in order to decrypt ciphertext encrypted using PRNG Array 120.

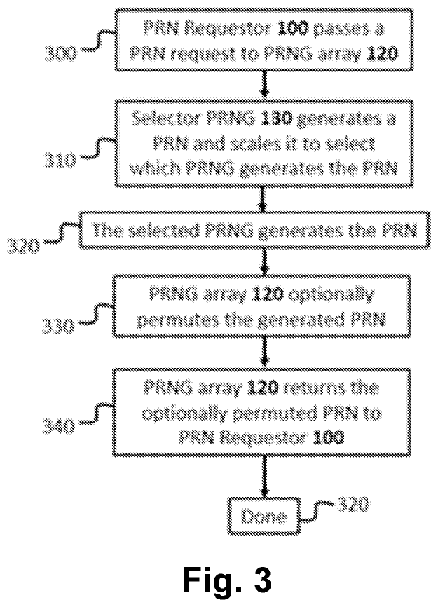

FIG. 3 provides an example of a high-level summary of steps that can be taken to provide PRNs to requestors. First, at 300, an application determines it needs a PRN and emits a request to PRNG Array 120. In 310, PRNG Array 120 generates a preliminary PRN value it scales to produce an index. In 320, PRNG Array 120 uses the index to select which PRNG it will use to generate the requested PRN. In 330, the selected PRN generates the PRN which PRNG Array 120 optionally permutes. In 340, PRNG Array 120 returns the optionally permuted PRN to PRN Requestor 100.

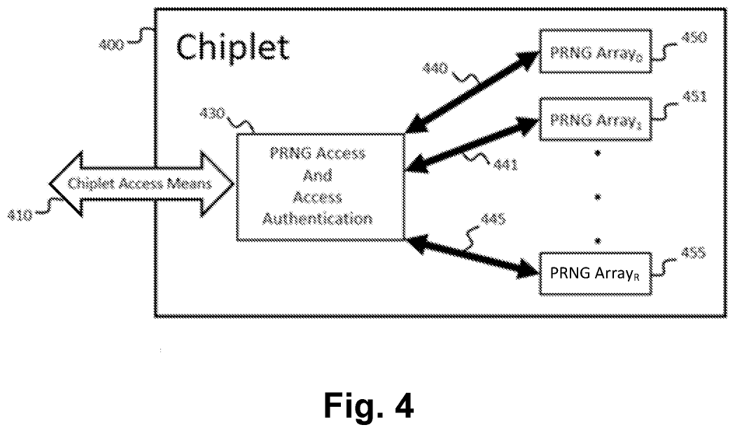

FIG. 4 depicts an example of a Chiplet 400 implementation with multiple PRNG Array 120 instantiations 450, 451, . . . , 455. The chiplet 400 has a Chiplet Access Means 410 well understood by practitioners skilled in the art. This chiplet access means 410 provides a means for Chiplet 400 to receive external PRN requests and transmit generated results to requestors 100.

It is to be understood that to prevent PRNG 450, 451, . . . , 455 operational interference from hostile or defective computer system applications, PRN requests to Chiplet 400 can include PRNG 450, 451, . . . , 455 access authentication information that is established when a computing system allocates 450, 451, . . . , 455 for exclusive use.

In summary, in FIG. 4, via Chiplet Access Means 410, PRNG access means 430 receives computing system application requests for a specific PRNG 450, 451, . . . , 455 to provide a PRN value along with optional access authentication information. PRNG access means 430 authenticates the optional request access and relays the request to the specific PRNG 450, 451, . . . , 455 the request specified. Using its generation means, PRNG 450, 451, . . . , 455 generates a PRN and transmits it to PRNG access means 430. PRNG access means 430 relays the PRNG to the requestor 100 using Chiplet Access Means 410.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device.

The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that may be accessed by a computing device. By way of example, and not limitation, computer-readable media may comprise computer storage media and communication media.

It will be appreciated that variants of the above-disclosed and other features and functions, or alternatives thereof, may be combined into many other different systems or applications.

Various presently unforeseen or unanticipated alternatives, modifications, variations, or improvements therein may be subsequently made by those skilled in the art which are also intended to be encompassed by the following claims.

1. A multiplicity-dimensioned array of pseudo random number generation means, each array member using an independent selector pseudo random number generator means to generate a pseudo random number value used to identify a second pseudo random number generator means within a multiplicity of pseudo random number generator means, the second pseudo random number generator means producing a value that is returned to a pseudo random number generator requestor unchanged.

2. A means to enable a multiplicity of requestors exclusive access to specific Pseudo Random Number Generation means within the multiplicity-dimensioned array of pseudo random number generation means according to claim 1.

3. A chiplet implementation of the multiplicity-dimensioned array of pseudo random number generation means according to claim 1.

4. An allocation and access verification means enabling a pseudo random number generation means access and configuration within the multiplicity-dimensioned array of pseudo random number generation means according to claim 1.

5. A multiplicity-dimensioned array of pseudo random number generation means, each array member using an independent selector pseudo random number generator means to generate a pseudo random number value used to identify a second pseudo random number generator means within a multiplicity of pseudo random number generator means, the second pseudo random number generator means producing a value that is returned to a pseudo random number generator requestor after its value is altered or otherwise permuted.

6. A means to enable a multiplicity of requestors exclusive access to specific Pseudo Random Number Generation means within a multiplicity-dimensioned array of pseudo random number generation means as in claim 5.

7. A chiplet implementation of the multiplicity-dimensioned array of pseudo random number generation means according to claim 5.

8. An allocation and access verification means enabling a pseudo random number generation means access and configuration within the multiplicity-dimensioned array of pseudo random number generation means according to claim 5.

9. A Fortified Linear Congruential Generator means using a multiplicity of multiplier values and a multiplicity of increment values, any increment value being optionally permuted after each use.

10. A multiplicity-dimensioned array of pseudo random number generation means, each array member using a looping index value selection means to identify a second pseudo random number generator means within a multiplicity of pseudo random number generator means, the second pseudo random number generator means producing a value that is returned to a pseudo random number generator requestor unchanged.

11. A chiplet implementation of the multiplicity-dimensioned array of pseudo random number generation means according to claim 10.

12. An allocation and access verification means enabling a pseudo random number generation means access and configuration within the multiplicity-dimensioned array of pseudo random number generation means according to claim 10.

13. A multiplicity-dimensioned array of pseudo random number generation means, each array member using a looping index value selection means to identify a second pseudo random number generator means within a multiplicity of pseudo random number generator means, the second pseudo random number generator means producing a value that is returned to a pseudo random number generator requestor after its value is altered or otherwise permuted.

14. A chiplet implementation of the multiplicity-dimensioned array of pseudo random number generation means according to claim 13.

15. An allocation and access verification means enabling a pseudo random number generation means access and configuration within the multiplicity-dimensioned array of pseudo random number generation means according to claim 13.

16. A multiplicity-dimensioned array of pseudo random number generation means that returns a superfluous value when it detects an unauthorized access request.

17. A chiplet implementation of the multiplicity-dimensioned array of pseudo random number generation means according to claim 16.

18. An allocation and access verification means enabling a pseudo random number generation means access and configuration within the multiplicity-dimensioned array of pseudo random number generation means according to claim 16.

19. A multiplicity-dimensioned array of pseudo random number generation means that interprets input parameter requests as either a request to configure a member of a multiplicity-dimensioned array of pseudo random number generation means or a request for the multiplicity-dimensioned array of pseudo random number generation means to generate and provide a pseudo random number value.

20. A chiplet implementation of the multiplicity-dimensioned array of pseudo random number generation means according to claim 19.

21. An allocation and access verification means enabling a pseudo random number generation means access and configuration within the multiplicity-dimensioned array of pseudo random number generation means according to claim 19.
